(19) United States
(12) Patent Application Publication
(10) Pub. No.: US 2006/0046779 A1
(43) Pub. Date: Mar. 2, 2006

(54) Method and apparatus for providing enhanced functionality for a mobile communication device

(76) Inventors: James L. Tracy, Coral Springs, FL (US); Jaime A. Borras, Hialeah, FL (US); Georg A. Mussenden, Boca Raton, FL (US)

Correspondence Address: MOTOROLA, INC;INTELLECTUAL PROPERTY SECTION, LAW DEPT, 8000 WEST SUNRISE BLVD, FT LAUDERDAL, FL, 33322, US

(21) Appl. No.: 10/930,061

(22) Filed: Aug. 31, 2004

(51) Int. Cl. H04M 1/00

(52) U.S. Cl. 455/557; 455/575.1

(57) ABSTRACT

A mobile communication device is provided with an electrical interface in a battery compartment (204) of the mobile communication device. The interface is provided by a flexible circuit member (106) disposed on a radiation shield (100), which is mounted on a circuit board (14) of the mobile communication device. The flexible circuit member and shield are accessible through an opening (206) in the back surface (210) of the battery compartment. Initially the mobile communication device is provided with a label (214) concealing the electrical interface. The label may be removed later so that a battery accessory module (600) may replace a standard battery (502). An accessory circuit (808) in the battery accessory module connects to the mobile communication device through the interface, and provides additional functionality to the mobile communication device.

### FIELD OF THE INVENTION

This invention relates in general to the field of portable electronic devices, and more particularly to accessories for portable electronics and means of connecting accessory modules to host portable electronic devices, and to methods of selling electronic devices so that enhanced functionality is available to a user of the device after initially purchasing the device.

### BACKGROUND OF THE INVENTION

As portable electronic devices tend to include increasing computing power, manufacturers have designed such devices to host a variety of accessory devices through various connectors such as cables, wires, and multi-conductor pin and socket type connectors. However, cables tend to get lost, and other connectors often result in an awkward combination of host and accessory.

Most mobile communication devices, for example, have a connector port for connecting cables and other device to so that the mobile communication device can perform additional functions. The use of a cable and connector, however, can hamper the use of the device if it is meant to be used in a mobile fashion. Furthermore, many applications may reside within a “clip-on” type of accessory which connects to the host device. Users generally prefer to have more integrated solutions, rather than a variety of pieces to connect together each time they wish to use some additional functionality. Furthermore, the use of conventional connectors and sockets typically add a significant cost to the device which users who may not ever need additional functionality still must pay for. Therefore there is a need for a means by which enhanced functionality may be provided to a user without substantially impacting the cost of the device, and still allowing for neat and compact addition of functionality to the device.

### BRIEF DESCRIPTION OF THE DRAWINGS

Various other objects, advantages, and features of the invention will become apparent to those skilled in the art from the following discussion taken in conjunction with the following drawings, in which:

FIG. 1 shows a radiation shield with an electrical interface disposed thereon, mounted on a circuit board, in accordance with an aspect of the invention;

FIG. 2, shows an exploded isometric view of a mobile communication device in accordance with an aspect of the invention;

FIG. 3, shows a back view of an assembled mobile communication device in accordance with an embodiment of the invention;

FIG. 4 shows an assembled mobile communication device in accordance with an embodiment of the invention, showing how the electrical interface may be concealed;

FIG. 5 shows a side break-away view of the mobile communication device in accordance with an embodiment of the invention;

FIG. 6 shows a side break-away view of the mobile communication device in accordance with an embodiment of the invention;

FIG. 7 shows a bottom isometric view of a battery accessory module, in accordance with an embodiment of the invention;

FIG. 8 shows a block diagram electrical schematic of a battery accessory module, in accordance with an embodiment of the invention;

FIG. 9 shows an accessory module table showing rows corresponding to the pins of an electrical interface, in accordance with an embodiment of the invention; and

FIG. 10 shows a flow chart diagram of a method for providing enhanced functionality in a mobile communication device, in accordance with an embodiment of the invention.

### DETAILED DESCRIPTION OF THE INVENTION

While the specification concludes with claims defining the features of the invention that are regarded as novel, it is believed that the invention will be better understood from a consideration of the following description in conjunction with the drawing figures, in which like reference numerals are carried forward.

The invention solves the problem of limited ability to increase or enhance the functionality of a mobile communication device by providing a concealed electrical interface in a battery compartment of the mobile communication device. The electrical interface may be provided in the mobile communication device without substantially impacting the cost of the mobile communication device. The electrical interface may subsequently be used to provide electrical connectivity with an accessory module that includes a battery and fits within the battery compartment of the mobile communication device. By providing the additional functionality in this manner, the initial cost of the mobile communication device for consumer who will not require additional or enhanced functionality is lower than if all features are initially included. The invention provides more demanding users the opportunity to add virtually any additional functionality to the mobile communication device without having to tether the mobile communication device to another device via a cable, or use a hardware interface translator.

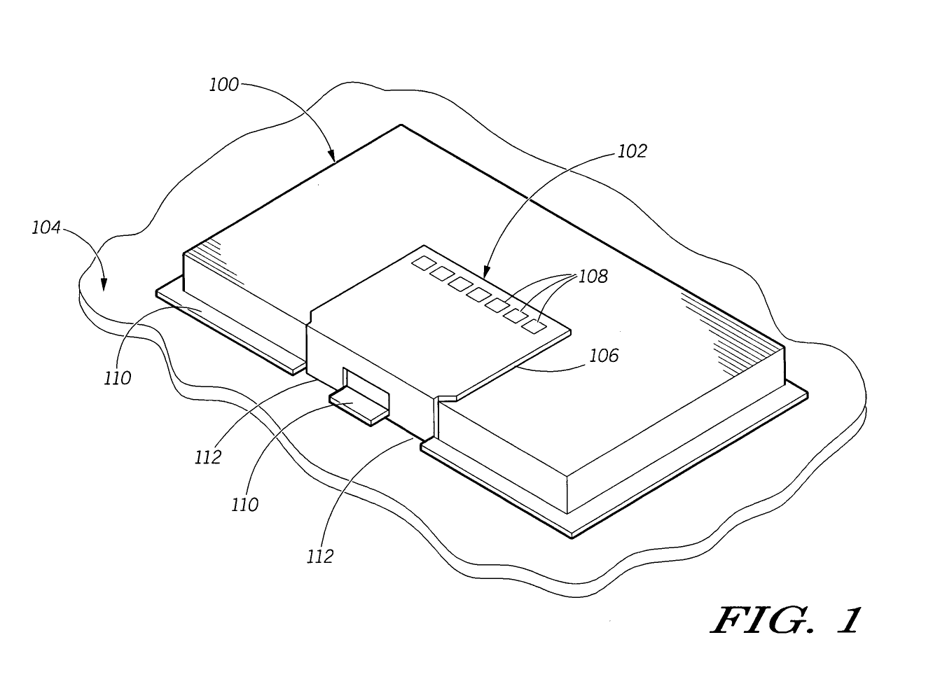

Referring now to FIG. 1 there is shown a radiation shield 100 with an electrical interface 102 disposed thereon, mounted on a circuit board 104, in accordance with an aspect of the invention. The radiation shield 100 comprises a metal or metallized box-like member, and is used to cover and decouple sensitive electronic circuitry from electromagnetic radiation which may affect operation of the circuitry. The shield may also be used to prevent electromagnetic radiation generated by the circuitry to “leak out” and affect nearby circuits. The electrical interface 102 is provided by a flexible circuit member 106 which has a plurality of conductor pads 108 exposed so that electrical contact may be made therewith. The flexible circuit member is mounted on the shield in a conventional manner, such as that taught in U.S. Pat. No. 6,452,811, the disclosure of which is hereby incorporated by reference. The shield 100 is attached to the circuit board 104 by, for example, reflow soldering of a flange 110 of the shield to exposed conductor on the board, in a conventional manner. The shield may be provided with cut outs 112, though which a portion of the flexible circuit member 106 may pass, and is electrically connected to the circuit board 104. In an alternative embodiment, it is contemplated that the flexible circuit member may be electrically connected to the circuit board by heat staking one end of the flexible circuit member to the circuit board outside of the shield, and adhesively affixing another portion of the flexible circuit member having the conductor pads 108 on top of the shield 100. The pads 108 of flexible circuit member provide for an electrical interface, and the cost of a flexible circuit member in accordance with the invention can be quite small and insubstantial compared to the overall cost of the mobile communication device.

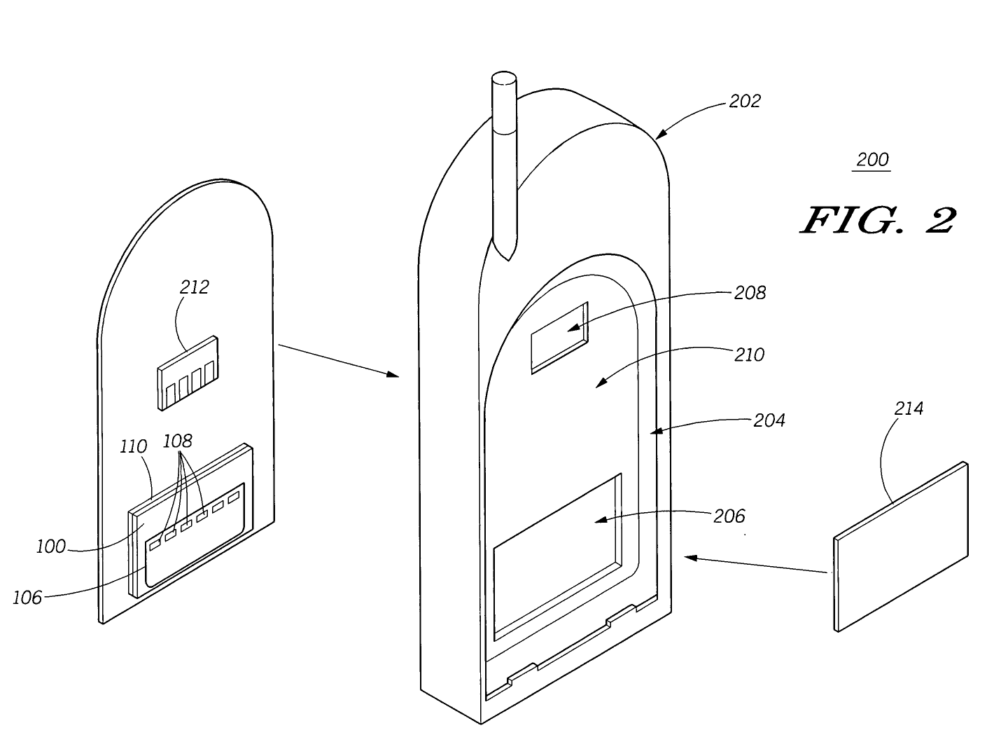

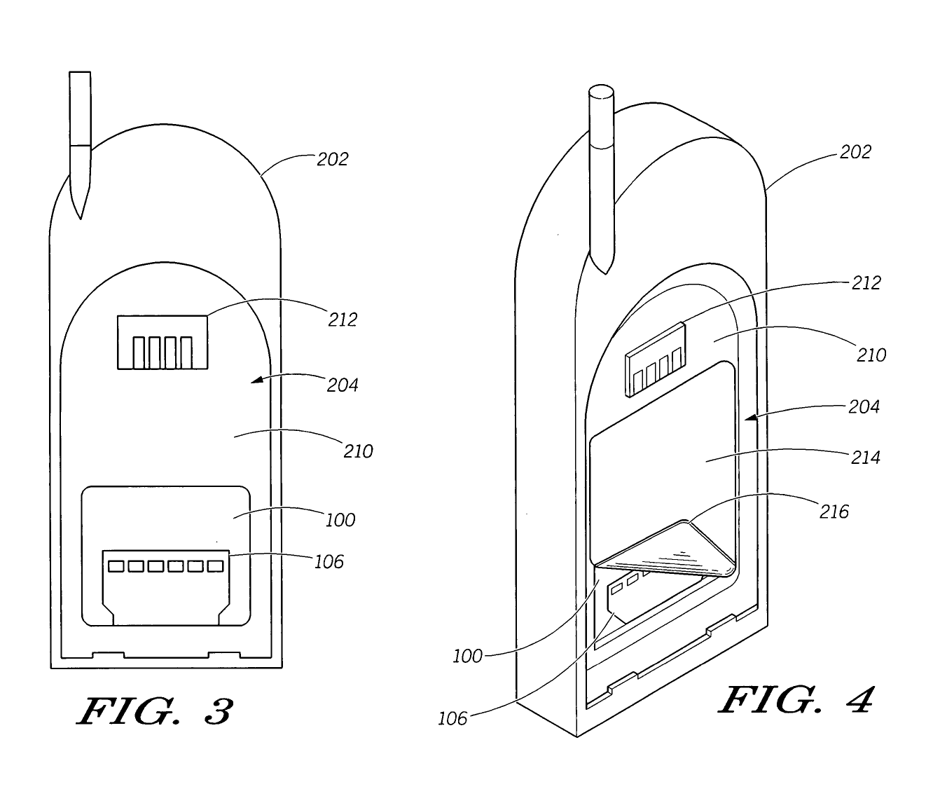

Referring now to FIG. 2, there is shown an exploded isometric view of a mobile communication device subassembly 200 in accordance with an aspect of the invention. The mobile communication device comprises a housing 202 having a battery compartment 204 recessed into the housing for retaining a battery therein for operating the mobile communication device. The battery compartment has a first opening 206 and may have a second opening 208 in the back surface 210 of the battery compartment. When the circuit board 104 is assembled into the housing 202, the shield 100 fits in the first opening 206 so that the conductor pads 108 of flexible circuit member 106 can be accessed in the battery compartment. It is also contemplated that a battery contact block 212 may be disposed on the circuit board, and will reside in the second opening 208 so that battery contacts may provide power to the mobile communication device. Finally, the shield and flexible circuit member are concealed by, for example, a label 214, or equivalent removable substrate, being disposed over them on the back surface 210 of the battery compartment 204. FIG. 3 shows a back view of an assembled mobile communication device in accordance with an embodiment of the invention. In FIG. 3 it can be seen that the shield and flexible circuit member fit in the first opening 206 in the back surface 210 of the battery compartment. It is preferred that the flexible circuit member be substantially flush with the back surface, and not protrude too far into the battery compartment, nor be recessed too far into the first opening.

Referring now to FIG. 4, there is shown an assembled mobile communication device in accordance with an embodiment of the invention, showing how the electrical interface may be concealed. A label 214 is placed over the back surface 210 of the battery compartment 204, concealing the shield 100 and flexible circuit member 106 with conductor pads. Here, a corner 216 of the label is shown lifted to reveal the shield 100 and flexible circuit member 106 beneath it. According to the invention, the mobile communication device may be initially sold into the marketplace with the label covering the shield and flexible circuit member, and is provided with a standard battery to power the mobile communication device through the battery contact block 212.

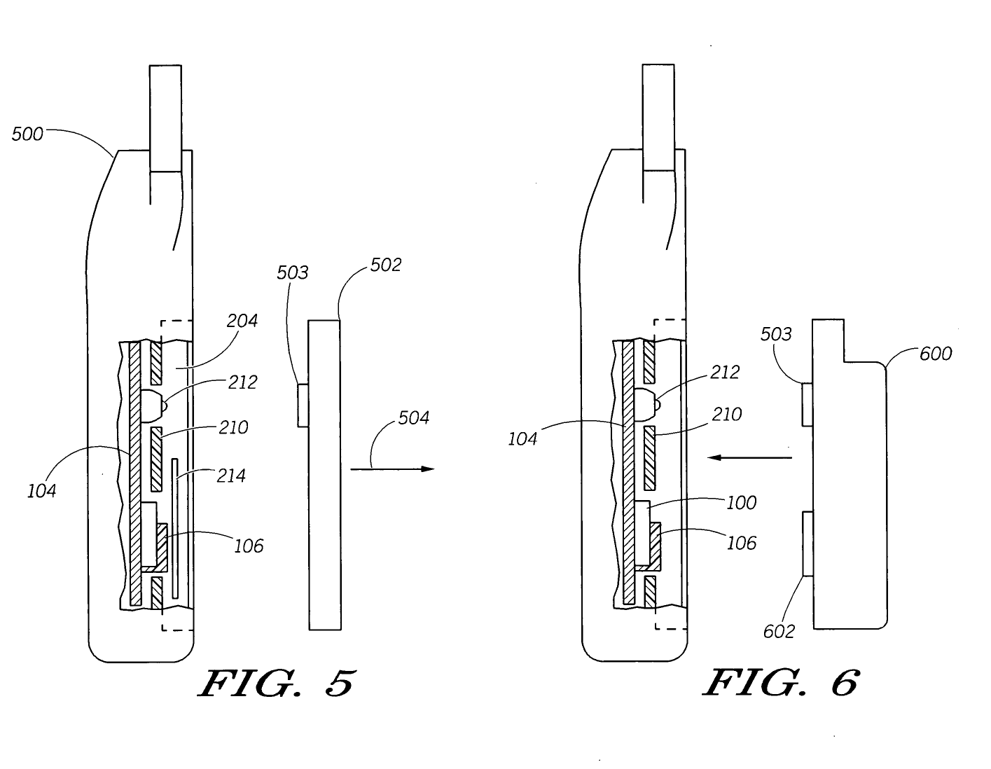

Referring now to FIG. 5, there is shown a side break-away view of the mobile communication device 500 in accordance with an embodiment of the invention. The battery compartment 204, the back surface 210 of the battery compartment, battery contact block 212, and label 214 are shown in dashed lines. A standard battery 502 which may be provided with the mobile communication device is also shown. The standard battery has battery contacts 503 which mate with the battery contact block 212 so that power may be provided to the mobile communication device. Furthermore, the standard battery is removable, as indicated by line 504.

Similar to FIG. 5, FIG. 6 also shows a side break-away view of the mobile communication device 500 in accordance with an embodiment of the invention. However, the label has been removed, exposing the shield 100 with the flexible circuit member to the battery compartment 204. A battery accessory module 600 is to be placed in the battery compartment. The battery accessory module is a combination battery pack and auxiliary circuit package, and is designed to fit into the battery compartment in the same way as a standard battery 502, but comprises accessory circuitry for additional functionality. The battery accessory module also includes battery contacts 503 because it also contains a battery for powering the mobile communication device. The battery accessory module also includes an interface connector 602 for connecting the accessory circuitry disposed within the battery accessory module to the mobile communication device through the flexible circuit member. The pads 108 of the flexible circuit member mate with the individual conductors on the interface connector 602. An advantage to using the flexible circuit member and pads to provide an electrical interface is that contact is made without binding the interface connector 602 to the mobile communication device, which makes it easy to use for a user of the mobile communication device. By binding it is meant a friction fit connector where, for example, a male connector is retained with friction in a mating female connector.

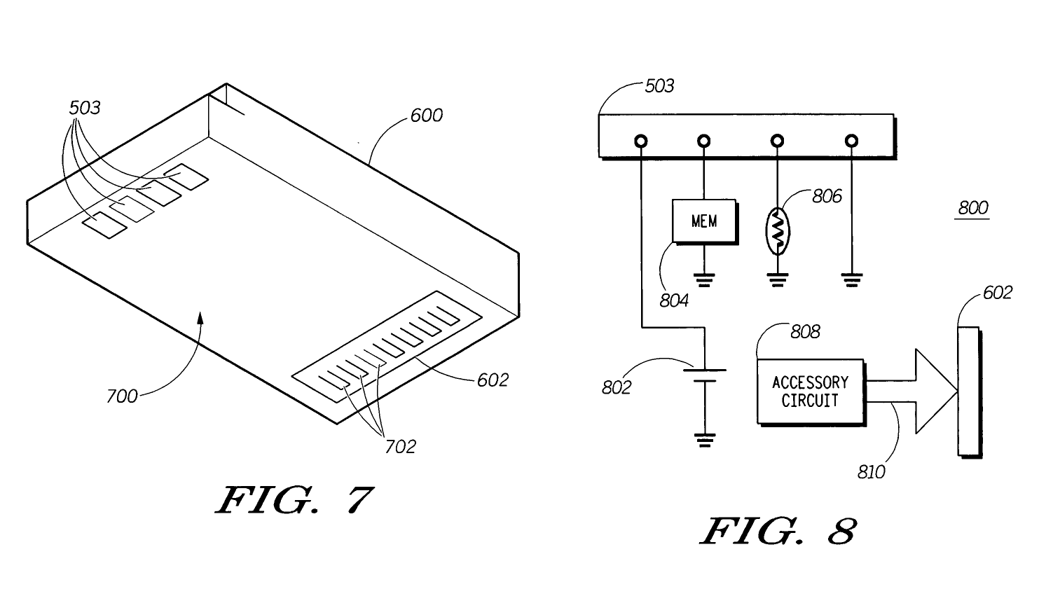

Referring now to FIG. 7, there is shown a bottom isometric view of a battery accessory module 600, in accordance with an embodiment of the invention. As described in reference t FIG. 6, the battery accessory module is sized to fit within the battery compartment of the mobile communication device, and be releasably retained therein, as with a standard battery, though the use of conventional latches or covers, for example. It can be seen the battery contacts 503 are disposed on a bottom surface 700 of the battery accessory module. The bottom surface 700 mate with the back surface 210 of the battery compartment 204 of the mobile communication device. The interface connector 602 comprises a plurality of individual conductors 702, each of which mates with one of the conductor pads 108. The conductors 702 may be cantilevered or otherwise spring-fit conductors to ensure sufficient pressure between the conductor 702 and the pads 108.

Referring now to FIG. 8, there is shown a block diagram electrical schematic 800 of a battery accessory module 600, in accordance with an embodiment of the invention. The accessory module comprises a battery 802 for providing power to the electronic device, and is preferably a rechargeable battery. The accessory module also may contain standard battery components such as a memory 804 for storing battery parameters or battery identification information, and a thermistor 806 for us in charging the battery. The battery components are connected to the battery contacts 503. The battery accessory module also comprises an accessory circuit 808, which has a plurality of signal lines and power lines 810 connected to the interface connector 602. The accessory circuit may be any number of circuits for providing a variety of additional functionality to the mobile communication device, including, a wireless local area network media access circuit, a satellite positioning receiver circuit, or a wireless data modem circuit, and the accessory circuit may or may not include its own antenna. Note that the accessory circuit, while residing in the battery accessory module, is not connected to the battery 802. Instead, power is routed from the battery to the host device through the battery contacts, and then to the accessory circuit through the flexible circuit member and interface connector. By not connecting the accessory circuit to the battery inside the battery accessory module, the accessory circuit does not drain the battery charge when the battery accessory module is not in use. It is further contemplated that the host device may switch power to the accessory circuit on and off as needed to preserve battery charge.

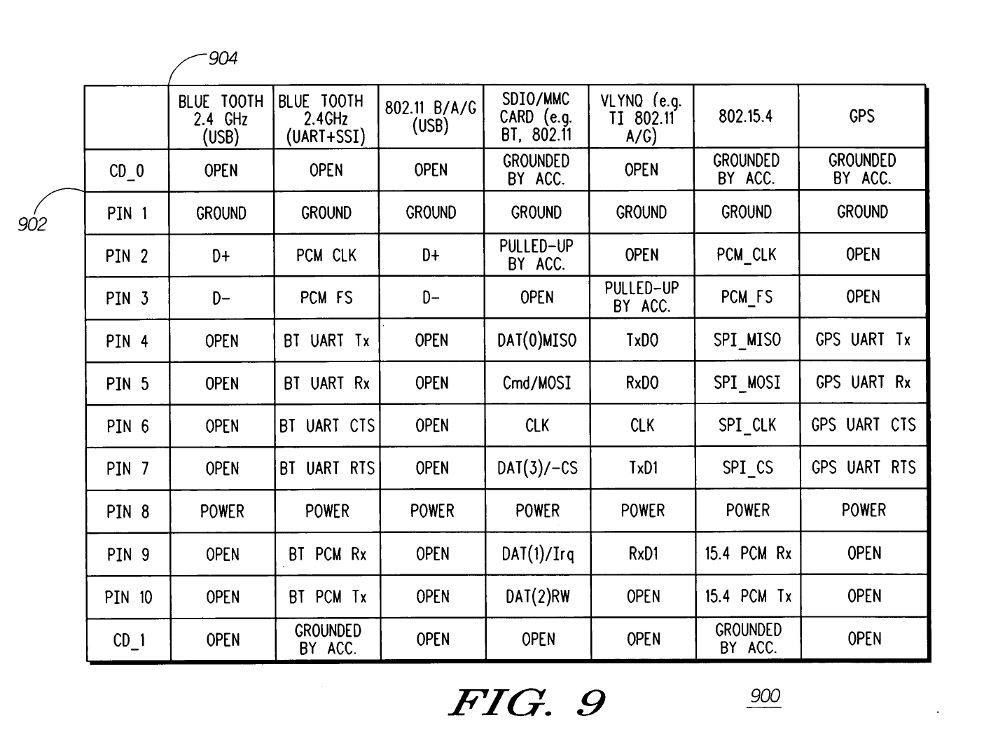

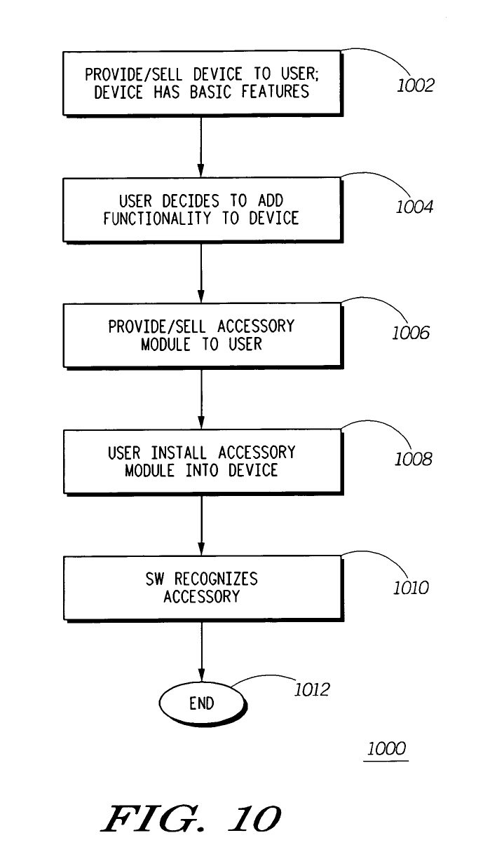

Referring now to FIG. 9, there is shown an accessory module table 900 showing rows 902 corresponding to the pins of an electrical interface in accordance with an embodiment of the invention. The interface is physically realized when the pads 108 of the flexible circuit member mate with their respective conductors 702 of the battery accessory module. Each column 904 shows a possible pin out for the interface to a different type of accessory circuit that maybe contained with the accessory module. In the table the term “open” refers to the pin not being used by the accessory circuit; the term “ground” refers to the ground or reference voltage potential; “grounded by acc.” means the pin is grounded by the accessory; and “pwr” is where electrical power or a power voltage potential is supplied by the device. The other entries are as known for their respective accessory circuits, which are, from left to right: BlueTooth® local wireless network interface at 2.4 Gigahertz; Universal Serial Bus, an industry standard, 4-wire interface used to attach external peripherals to a “host controller” such as a Personal Computer or any intelligent device; BlueTooth® 2.4 GHz UART which is a wireless industry peripheral device communications standard, and similar to USB for adding peripherals to intelligent host controllers; IEEE 802.11 B, or A, or G standard wireless networking; SDIO/MMC Card, which is a form factor and interface standard for small accessory cards which usually embody communication or data storage functionalities and are generally removable storage media device; VLYNQ, which is a peripheral attachment bus, mostly for peripherals embedded in a device; IEEE 802.15.4, which is a wireless control standard to enable intelligent devices to control other devices typically used to control building lights, HVAC etc., and can also be used for some limited general communications between such devices, and is pertinent to mobile communication devices as it is expected that future mobile communication devices will be able to control the home's electrical devices; and a global positioning satellite receiver.

Referring now to FIG. 10, there is shown a flow chart diagram 1000 of a method for providing enhanced functionality in a mobile communication device, in accordance with an embodiment of the invention. The mobile communication device is initially provided (1002) to a user, with the label covering the shield and flexible circuit member. The mobile communication device may be provided in a variety of ways, such as the user purchasing the mobile communication device, or the mobile communication device being loaned to the user for employment purposes, for example. The user may decide that additional functionality is needed, either at the time of receiving the mobile communication device, or at another time (1004). To fulfill the user's need, a battery accessory module is also provided to the user (1006). The user may purchase the battery accessory module, or it may be given or loaned to the user, for example. The user, or a person associated with the user, such as a salesperson, for example, installs the battery accessory module into the mobile communication device (1008). The installation comprises removing a standard battery, or other battery accessory module, revealing the flexible circuit member so that the pads may be accessed, and placing the battery accessory module into the battery compartment of the mobile communication device. Once the battery accessory module has been installed, software in the mobile communication device recognizes detects the presence of the battery accessory module, and determines what type of accessory circuit resides in the battery accessory module so that appropriate driver software may be instantiated, thereby allowing the user of the mobile communication device use of the functionality provided by the accessory circuit (808). The process is then complete (1012), with the user having additional functionality not initially provided in the mobile communication device. Since the battery accessory module resides in the battery compartment, it is expected that the physical size of the resulting combination will be similar enough to using a standard battery that is doesn't interfere with use of the mobile communication device.

While the invention has been described, disclosed, illustrated and shown in certain terms or certain embodiments or modifications which it has assumed in practice, the scope of the invention is not intended to be nor should it be deemed to be limited thereby and such other modifications or embodiments as may be suggested by the teachings herein are particularly reserved especially as they fall within the breadth and scope of the claims here appended.

What is claimed is:

1. A method of providing enhanced functionality for a mobile communication device, comprising:
providing the mobile communication device with an electrical interface in a battery compartment of the mobile communication device, the electrical interface being formed by a flexible circuit member disposed on top of a radiation shield mounted on a circuit board inside the mobile communication device, the flexible circuit member being accessible through an opening in a back surface of the battery compartment;
providing a removable substrate over the electrical interface upon manufacture of the mobile communication device;
wherein the removable substrate is removed subsequently to install a battery accessory module in the battery compartment of the mobile communication device, the battery accessory module comprising a battery and an accessory circuit and an interface connector for mating with the electrical interface of the mobile communication device.

2. A method of providing enhanced functionality as defined in claim 1, wherein providing a removable substrate comprises providing a label.

3. A method of providing enhanced functionality in a mobile communication device, comprising:
providing the mobile communication device with a concealed electrical interface in a battery compartment of the mobile communication device, the electrical interface being concealed by a removable substrate;
removing the removable substrate from the battery compartment; and
installing a battery accessory module into the battery compartment.

4. A method of providing enhanced functionality as defined in claim 3, wherein providing the mobile communication device with a concealed electrical interface comprises providing the mobile communication device with:
a circuit board disposed inside the mobile communication device;
a radiation shield mounted on the circuit board; and
a flexible circuit member mounted on top of the radiation shield, and having a plurality of conductor pads;
wherein the radiation shield is fit with an opening in a back surface of the battery compartment.

5. A method of providing enhanced functionality as defined in claim 3, wherein the removable substrate is a label.

6. A method of providing enhanced functionality as defined in claim 3, wherein the battery accessory module is one of: a wireless local area network media access circuit, a satellite positioning receiver circuit, a removable storage media, and a wireless data modem circuit.

7. A mobile communication device, comprising:
a housing having a battery compartment with an opening in a back surface of the battery compartment;
a circuit board disposed inside the mobile communication device;
a radiation shield mounted on top of the circuit board, and extending into the opening in the back surface of the battery compartment;
a flexible circuit member mounted on top of the radiation shield and having a plurality of conductor pads for providing an electrical interface with the mobile communication device; and
a removable substrate for concealing the flexible circuit member and radiation shield, disposed in the battery compartment of the mobile communication device;
wherein the electrical interface is for interfacing with an interface connector of a battery accessory module.

8. A mobile communication device as defined in claim 7, wherein the removable substrate is a label.

9. A mobile communication device as defined in claim 7, wherein the battery accessory module is one of: a wireless local area network media access circuit, a satellite positioning receiver circuit, a removable media device, and a wireless data modem circuit.
